(19) United States
(12) Patent Application Publication
(10) Pub. No.: US 2023/0262500 A1
(43) Pub. Date: Aug. 17, 2023

(54) RELAYING BEAM FAILURE DETECTION REPORTS

(71) Applicant: QUALCOMM Incorporated, San Diego, CA (US)

(72) Inventors: Shanyu Zhou, San Diego, CA (US); Jelena Damnjanovic, Del Mar, CA (US); Tao Luo, San Diego, CA (US)

(21) Appl. No.: 17/674,211

(22) Filed: Feb. 17, 2022

(51) Int. Cl. H04W 24/10; H04W 24/08

(52) U.S. Cl. CPC H04W 24/10; H04W 24/08

(57) ABSTRACT

Methods, systems, and devices for wireless communications are described. A user equipment (UE) may receive control signaling indicating a configuration for reporting beam failure detection (BFD) reports via a relay device. The UE may also receive a control message activating BFD reporting at the UE in accordance with the configuration. The UE may monitor for reference signals from a network entity, and may determine one or more beam failure instance (BFI) indicators that pertain to communications between the UE and the network entity. The UE may transmit a BFD report via the relay device in accordance with the configuration. The UE may transmit the BFD report prior to a beam failure declaration that occurs when a quantity of the one or more BFI indicators exceeds a threshold. The techniques described herein may reduce the likelihood of beam failures occurring between the UE and the network entity.

### FIELD OF TECHNOLOGY

The following relates to wireless communications, including relaying beam failure detection (BFD) reports.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE may use various techniques to detect and mitigate beam failures that occur during communications between the UE and a network entity. For example, the UE may be configured to perform a beam failure recovery (BFR) procedure in response to a beam failure declaration. In some cases, however, performing a BFR procedure may result in greater power consumption and increased latency at the UE.

### SUMMARY

The described techniques relate to improved methods, systems, devices, and apparatuses that support relaying beam failure detection (BFD) reports. For example, the described techniques may enable a network entity to receive BFD status information from a user equipment (UE) via a relay device, which may enable the network entity to mitigate beam failures that occur between the UE and the network entity. In accordance with aspects of the present disclosure, the UE may receive control signaling indicating a configuration for reporting BFD reports via the relay device. The UE may also receive a control message activating BFD reporting at the UE in accordance with the configuration. The UE may monitor for one or more reference signals from the network entity, and may determine one or more beam failure instance (BFI) indicators that pertain to communications between the UE and the network entity. The UE may transmit a BFD report via the relay device in accordance with the configuration. The UE may transmit the BFD report prior to a beam failure declaration that occurs when a quantity of the one or more BFI indicators exceeds a threshold. The techniques described herein may reduce the likelihood of beam failures occurring between the UE and the network entity.

A method for wireless communications at a UE is described. The method may include receiving control signaling indicating a configuration for reporting, via a relay device, one or more BFD reports, receiving a control message activating BFD reporting at the UE in accordance with the configuration, monitoring for one or more reference signals from a network entity to determine one or more BFIs with respect to communications between the UE and the network entity, and transmitting, via the relay device and in accordance with the configuration, a BFD report prior to a beam failure declaration by the UE, where the beam failure declaration is based on a quantity of the one or more BFIs exceeding a threshold.

An apparatus for wireless communications at a UE is described. The apparatus may include a processor, memory coupled with the processor, and instructions stored in the memory. The instructions may be executable by the processor to cause the apparatus to receive control signaling indicating a configuration for reporting, via a relay device, one or more BFD reports, receive a control message activating BFD reporting at the UE in accordance with the configuration, monitor for one or more reference signals from a network entity to determine one or more BFIs with respect to communications between the UE and the network entity, and transmit, via the relay device and in accordance with the configuration, a BFD report prior to a beam failure declaration by the UE, where the beam failure declaration is based on a quantity of the one or more BFIs exceeding a threshold.

Another apparatus for wireless communications at a UE is described. The apparatus may include means for receiving control signaling indicating a configuration for reporting, via a relay device, one or more BFD reports, means for receiving a control message activating BFD reporting at the UE in accordance with the configuration, means for monitoring for one or more reference signals from a network entity to determine one or more BFIs with respect to communications between the UE and the network entity, and means for transmitting, via the relay device and in accordance with the configuration, a BFD report prior to a beam failure declaration by the UE, where the beam failure declaration is based on a quantity of the one or more BFIs exceeding a threshold.

A non-transitory computer-readable medium storing code for wireless communications at a UE is described. The code may include instructions executable by a processor to receive control signaling indicating a configuration for reporting, via a relay device, one or more BFD reports, receive a control message activating BFD reporting at the UE in accordance with the configuration, monitor for one or more reference signals from a network entity to determine one or more BFIs with respect to communications between the UE and the network entity, and transmit, via the relay device and in accordance with the configuration, a BFD report prior to a beam failure declaration by the UE, where the beam failure declaration is based on a quantity of the one or more BFIs exceeding a threshold.

In some examples of the method, apparatuses, and non-transitory computer-readable medium described herein, receiving the control signaling may include operations, features, means, or instructions for receiving, as part of the control signaling, information indicative of a periodicity for reporting, via the relay device, one or more BFD reports, where transmitting the BFD report is based on the periodicity.

In some examples of the method, apparatuses, and non-transitory computer-readable medium described herein, transmitting the BFD report may include operations, features, means, or instructions for transmitting an aperiodic BFD report based on determining that one or more trigger conditions may have been satisfied.

In some examples of the method, apparatuses, and non-transitory computer-readable medium described herein, receiving the control signaling may include operations, features, means, or instructions for receiving, as part of the control signaling, information indicative of the one or more trigger conditions for reporting, via the relay device, one or more aperiodic BFD reports.

In some examples of the method, apparatuses, and non-transitory computer-readable medium described herein, the one or more trigger conditions may be based on a quantity of consecutive BFIs exceeding a threshold, a total quantity of BFIs exceeding a threshold percentage of a parameter, a change in channel strength exceeding a threshold, or a combination thereof.

In some examples of the method, apparatuses, and non-transitory computer-readable medium described herein, transmitting the BFD report may include operations, features, means, or instructions for transmitting, as part of the BFD report, information indicative of a beam identifier, a spatial relationship between the beam identifier and the network entity, a BFI count associated with the one or more BFIs, a BFI record log, a set of channel measurements, an identifier of the UE, or a combination thereof.

In some examples of the method, apparatuses, and non-transitory computer-readable medium described herein, the set of channel measurements includes a signal to interference and noise ratio (SINR), a reference signal received power (RSRP) measurement, a pathloss measurement, an interference value, or a combination thereof.

In some examples of the method, apparatuses, and non-transitory computer-readable medium described herein, receiving the control signaling may include operations, features, means, or instructions for receiving information indicative of multiple configurations for reporting, via the relay device, one or more BFD reports.

In some examples of the method, apparatuses, and non-transitory computer-readable medium described herein, receiving the control message may include operations, features, means, or instructions for receiving an indication that BFD reporting is activated at the UE in accordance with a first configuration of the multiple configurations.

Some examples of the method, apparatuses, and non-transitory computer-readable medium described herein may further include operations, features, means, or instructions for receiving one or both of a medium access control-control element (MAC-CE) or downlink control information (DCI) indicating that the UE is to switch from a first configuration of the set of multiple configurations to a second configuration of the set of multiple configurations.

Some examples of the method, apparatuses, and non-transitory computer-readable medium described herein may further include operations, features, means, or instructions for transmitting a request to activate BFD reporting at the UE, where receiving the control message is based on transmitting the request.

In some examples of the method, apparatuses, and non-transitory computer-readable medium described herein, transmitting the request may include operations, features, means, or instructions for transmitting one or both of a MAC-CE or uplink control information (UCI) indicating the request to activate BFD reporting at the UE.

Some examples of the method, apparatuses, and non-transitory computer-readable medium described herein may further include operations, features, means, or instructions for receiving a beam switch command based on transmitting the BFD report.

In some examples of the method, apparatuses, and non-transitory computer-readable medium described herein, receiving the beam switch command may include operations, features, means, or instructions for receiving one or both of a MAC-CE or DCI indicating the beam switch command.

Some examples of the method, apparatuses, and non-transitory computer-readable medium described herein may further include operations, features, means, or instructions for monitoring for a set of reference signals from the network entity based on transmitting the BFD report.

In some examples of the method, apparatuses, and non-transitory computer-readable medium described herein, transmitting the BFD report may include operations, features, means, or instructions for transmitting, via the relay device and in accordance with the configuration, a sidelink MAC-CE including the BFD report.

In some examples of the method, apparatuses, and non-transitory computer-readable medium described herein, receiving the control signaling may include operations, features, means, or instructions for receiving radio resource control (RRC) signaling indicating the configuration for reporting, via the relay device, one or more BFD reports.

In some examples of the method, apparatuses, and non-transitory computer-readable medium described herein, receiving the control message may include operations, features, means, or instructions for receiving one or both of a MAC-CE or DCI activating BFD reporting at the UE in accordance with the configuration.

A method for wireless communications at a network entity is described. The method may include transmitting control signaling indicating a configuration for reporting, by a UE and via a relay device, one or more BFD reports, transmitting a control message activating BFD reporting at the UE in accordance with the configuration, transmitting one or more reference signals, and receiving, via the relay device and in accordance with the configuration, a BFD report for the UE.

An apparatus for wireless communications at a network entity is described. The apparatus may include a processor, memory coupled with the processor, and instructions stored in the memory. The instructions may be executable by the processor to cause the apparatus to transmit control signaling indicating a configuration for reporting, by a UE and via a relay device, one or more BFD reports, transmit a control message activating BFD reporting at the UE in accordance with the configuration, transmit one or more reference signals, and receive, via the relay device and in accordance with the configuration, a BFD report for the UE.

Another apparatus for wireless communications at a network entity is described. The apparatus may include means for transmitting control signaling indicating a configuration for reporting, by a UE and via a relay device, one or more BFD reports, means for transmitting a control message activating BFD reporting at the UE in accordance with the configuration, means for transmitting one or more reference signals, and means for receiving, via the relay device and in accordance with the configuration, a BFD report for the UE.

A non-transitory computer-readable medium storing code for wireless communications at a network entity is described. The code may include instructions executable by a processor to transmit control signaling indicating a configuration for reporting, by a UE and via a relay device, one or more BFD reports, transmit a control message activating BFD reporting at the UE in accordance with the configuration, transmit one or more reference signals, and receive, via the relay device and in accordance with the configuration, a BFD report for the UE.

In some examples of the method, apparatuses, and non-transitory computer-readable medium described herein, transmitting the control signaling may include operations, features, means, or instructions for transmitting, as part of the control signaling, information indicative of a periodicity for the UE to report, via the relay device, one or more BFD reports, where receiving the BFD report is based on the periodicity.

In some examples of the method, apparatuses, and non-transitory computer-readable medium described herein, transmitting the control signaling may include operations, features, means, or instructions for transmitting, as part of the control signaling, information indicative of one or more trigger conditions for the UE to report, via the relay device, one or more aperiodic BFD reports.

In some examples of the method, apparatuses, and non-transitory computer-readable medium described herein, the one or more trigger conditions may be based on a quantity of consecutive BFIs exceeding a threshold, a total quantity of BFIs exceeding a threshold percentage of a parameter, a change in channel strength exceeding a threshold, or a combination thereof.

In some examples of the method, apparatuses, and non-transitory computer-readable medium described herein, receiving the BFD report may include operations, features, means, or instructions for receiving, as part of the BFD report, information indicative of a beam identifier, a spatial relationship between the beam identifier and the network entity, a BFI count, a BFI record log, a set of channel measurements, an identifier of the UE, or a combination thereof.

Some examples of the method, apparatuses, and non-transitory computer-readable medium described herein may further include operations, features, means, or instructions for transmitting a beam switch command for the UE based on receiving the BFD report.

In some examples of the method, apparatuses, and non-transitory computer-readable medium described herein, transmitting the beam switch command may include operations, features, means, or instructions for transmitting the beam switch command for the UE based on a BFI count indicated by the BFD report, a set of channel measurements indicated by the BFD report, a BFI reporting log indicated by the BFD report, a BFI count threshold, or a combination thereof.

In some examples of the method, apparatuses, and non-transitory computer-readable medium described herein, transmitting the control message may include operations, features, means, or instructions for transmitting the control message activating beam failure reporting at the UE based on a quality of service (QoS) threshold, a discontinuous reception (DRX) configuration of the UE, a DRX cycle length of the UE, an active DRX duration of the UE, an inactive DRX duration of the UE, a capability of the UE, or a combination thereof.

### BRIEF DESCRIPTION OF THE DRAWINGS

FIGS. 1 and 2 illustrate examples of wireless communications systems that support relaying beam failure detection (BFD) reports in accordance with one or more aspects of the present disclosure.

FIG. 3 illustrates an example of a BFD procedure that supports relaying BFD reports in accordance with one or more aspects of the present disclosure.

FIG. 4 illustrates an example of a process flow that supports relaying BFD reports in accordance with one or more aspects of the present disclosure.

FIGS. 5 and 6 show block diagrams of devices that support relaying BFD reports in accordance with one or more aspects of the present disclosure.

FIG. 7 shows a block diagram of a communications manager that supports relaying BFD reports in accordance with one or more aspects of the present disclosure.

FIG. 8 shows a diagram of a system including a device that supports relaying BFD reports in accordance with one or more aspects of the present disclosure.

FIGS. 9 and 10 show block diagrams of devices that support relaying BFD reports in accordance with one or more aspects of the present disclosure.

FIG. 11 shows a block diagram of a communications manager that supports relaying BFD reports in accordance with one or more aspects of the present disclosure.

FIG. 12 shows a diagram of a system including a device that supports relaying BFD reports in accordance with one or more aspects of the present disclosure.

FIGS. 13 through 16 show flowcharts illustrating methods that support relaying BFD reports in accordance with one or more aspects of the present disclosure.

### DETAILED DESCRIPTION

In some wireless communications systems, a user equipment (UE) may perform a beam failure detection (BFD) procedure to detect and mitigate beam failures between the UE and a network entity. To perform a BFD procedure, the UE may monitor a set of periodic reference signal occasions, determine a set of beam failure instance (BFI) indicators, and maintain a BFI count. If, for example, the BFI count exceeds a threshold prior to expiration of a BFD timer, the UE may declare beam failure and initiate a beam failure recovery (BFR) procedure to re-establish communications with the network entity. In some cases, however, performing a BFR procedure may result in higher power consumption and increased latency at the UE.

In accordance with aspects of the present disclosure, a UE may be configured to provide a network entity with a BFD report prior to declaring beam failure. The BFD report may include information pertaining to a BFD status of the UE (e.g., a current beam identifier, a BFI count, a set of channel measurements), which the network entity may use to identify and mitigate beam failures. Configuring the UE to provide the network entity with BFD reports prior to declaring beam failure may reduce the number of BFR procedures performed by the UE, which may result in greater power savings, decreased latency, and more reliable communications between the UE and the network entity.

In some examples, the UE may be configured to transmit the BFD report to the network entity via a relay device that is connected to the UE and the network entity. For example, the UE may transmit a BFD report to the relay device over a sidelink channel, and the relay device may forward the BFD report to the network entity over an uplink channel. To support the techniques described herein, the UE may receive control signaling indicating a configuration for transmitting BFD reports to the network entity via the relay device. This configuration may indicate, for example, a BFD reporting periodicity (e.g., for periodic BFD reports) or a set of BFD reporting trigger conditions (e.g., for aperiodic BFD reports).

Aspects of the present disclosure may be implemented to realize one or more of the following advantages. The described techniques may improve the reliability of communications between a UE and a network entity by reducing the likelihood of beam failures occurring between the UE and the network entity. More specifically, the techniques described herein may enable the network entity to receive BFD status information from the UE via a relay device, which may enable the network entity to more effectively detect and mitigate beam failures between the UE and the network entity. Moreover, the techniques described herein may reduce a number of BFR procedures performed by the UE, which may result in reduced power consumption and decreased latency at the UE.

Aspects of the disclosure are initially described in the context of wireless communications systems, BFD procedures, and process flows. Aspects of the disclosure are further illustrated by and described with reference to apparatus diagrams, system diagrams, and flowcharts that relate to relaying BFD reports.

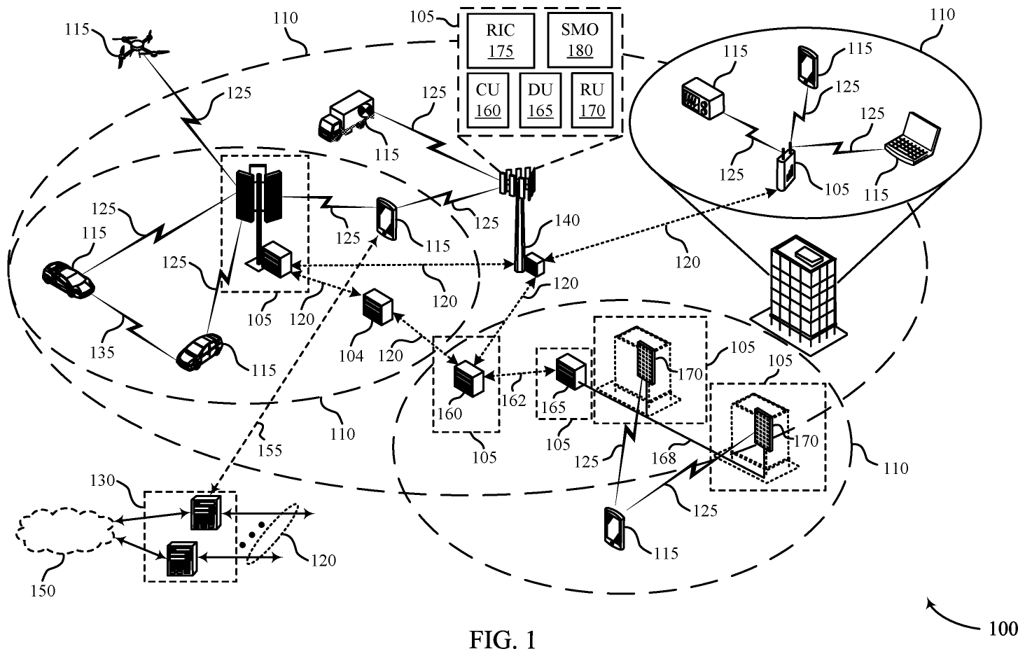

FIG. 1 illustrates an example of a wireless communications system 100 that supports relaying BFD reports in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support relaying BFD reports as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). The region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beam forming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

In some wireless communications systems that support 5G NR communications in mmW frequency ranges, devices can use beamforming techniques to concentrate signal energy in a specific direction to compensate for transmission power loss. Due to the relatively variable nature of wireless channels and blockages that can obstruct these channels, beams may be subject to beam failures. In some cases, a UE 115 may perform a BFR procedure to recover Uu link beams (e.g., via a random access channel (RACH) procedure), which may result in extraneous power consumption and increased latency. In some systems that support multi-connectivity, a source UE 115 may be connected to a relay UE 115 via a sidelink connection (e.g., a PC5 interface). The relay UE 115 may receive data from the source UE 115 over this sidelink connection, and may relay the data to a network entity 105 via a Uu link.

In some cases, if the source UE 115 is able to provide BFD status information to the network entity 105, the network entity 105 may be capable of estimating beam conditions with greater accuracy, which may enable the network entity 105 to mitigate (e.g., avoid) potential beam failures. Aspects of the present disclosure support techniques for improved beam failure management in multi-connectivity scenarios. More specifically, the techniques described herein provide for configuring a source UE 115 to provide a network entity 105 with BFD status information via a cooperative relay device, which may reduce the likelihood of beam failures occurring between the source UE 115 and the network entity 105.

The wireless communications system 100 may support techniques for improving the reliability of communications between a UE 115 and a network entity 105 by reducing the likelihood of beam failures occurring between the UE 115 and the network entity 105. More specifically, the techniques and operations described with reference to FIG. 1 may enable a network entity 105 to receive BFD reports from a UE 115 via a relay device, which may enable the network entity 105 to more effectively detect and mitigate beam failures between the UE 115 and the network entity 105. Moreover, the described techniques may reduce a number of BFR procedures performed by the UE 115, which may result in reduced power consumption and decreased latency at the UE 115, among other benefits.

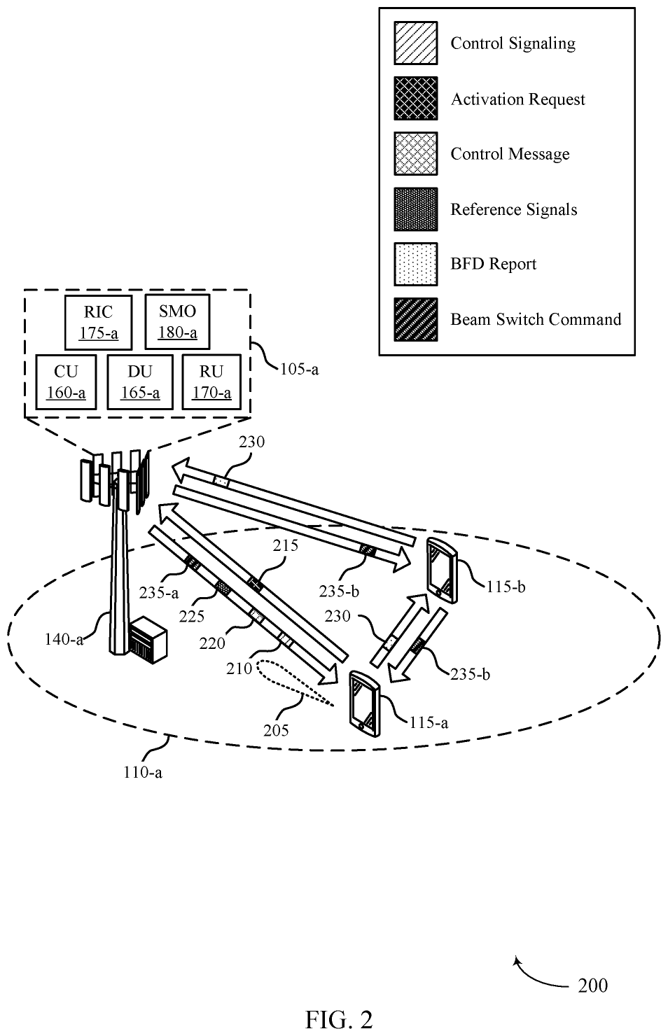

FIG. 2 illustrates an example of a wireless communications system 200 that supports relaying BFD reports in accordance with one or more aspects of the present disclosure. The wireless communications system 200 may implement or be implemented by aspects of the wireless communications system 100. For example, the wireless communications system 200 may include a UE 115-a, a UE 115-b, and a network entity 105-a, which may be examples of corresponding devices described with reference to FIG. 1. The UEs 115 and the network entity 105-a may communicate within a coverage area 110-a, which may be an example of a coverage area 110 described with reference to FIG. 1. In the wireless communications system 200, the UE 115-a (e.g., a source UE) may relay a BFD report 230 to the network entity 105-a via the UE 115-b (e.g., a relay UE).

As described with reference to FIG. 1, the network entity 105-a may include an RIC 175-a, a SMO 180-a, a CU 160-a, a DU 165-a, an RU 170-a, a base station 140-a, or a combination thereof. Communications between the network entity 105-a and the UE 115-a may refer to communications between the UE 115-a and any portion (e.g., entity, sub-entity) of the network entity 105-a. In the following description of the wireless communications system 200, the terms “transmitting,” “receiving,” or “communicating,” when referring to the network entity 105-a, may refer to any portion of the network entity 105-a (e.g., the base station 140-a, the CU 160-a, the DU 165-a, the RU 170-a) communicating with the UE 115-a (e.g., directly or via one or more other network entities 105).

In the example of FIG. 2, the UE 115-a (e.g., a source UE) may be connected to the network entity 105-a via a first Uu link, and the UE 115-b may be connected to the network entity 105-a via a second Uu link. The UE 115-a may be connected to the UE 115-b (e.g., a relay UE) over a PC5 interface. The UE 115-a and the network entity 105-a may communicate with each other directly (e.g., over the first Uu link) or via the UE 115-b (e.g., over the PC5 interface). In accordance with the described techniques, the UE 115-b may be configured to relay a BFD report 230 from the UE 115-a to the network entity 105-a.

Content of the BFD report 230 may include an identifier of a beam 205 (e.g., a current beam of the UE 115-a), a spatial relationship between the beam 205 and the network entity 105-a, a BFI count of the UE 115-a, a BFI record history of the UE 115-a, channel condition measurements (e.g., signal to interference and noise ratio (SINR), reference signal received power (RSRP), pathloss, interference value) recorded by the UE 115-a, or a combination thereof. The UE 115-a may signal the BFD report 230 to the UE 115-b via a sidelink MAC-control element (CE). Accordingly, the UE 115-b may forward the BFD report 230 to the network entity 105-a via a MAC-CE or uplink control information (UCI). In some examples, the network entity 105-a may specify what content to include in the BFD report 230 via control signaling 210. The control signaling may, in some examples, include RRC signaling or system information. In some examples, the network entity 105-a may configure the UE 115-a with multiple BFD reporting configurations, and may configure the UE 115-a to switch between configurations using downlink control information (DCI) or a MAC-CE.

The BFD report 230 may be an example of a periodic BFD status report or an aperiodic BFD status report. For periodic BFD reporting, the UE 115-a may transmit the BFD report 230 with a specific periodicity (e.g., f). For aperiodic BFD reporting (e.g., event-based BFD status reporting), the UE 115-a may transmit the BFD report 230 if one or more trigger conditions are satisfied. These trigger conditions may depend on a consecutive number (e.g., N) of BFI recordings exceeding a threshold, a total BFI count exceeding a specific percentage of a threshold (e.g., maxCount), or a decrease in channel strength (measured in dB) exceeding a threshold, among other examples. In some examples, the network entity 105-a may specify a periodicity (for periodic BFD reports) or trigger conditions (for aperiodic BFD reports) via the control signaling 210 (e.g., in an RRC configuration). In some examples, the UE 115-a may be configured with multiple periodicities or triggering conditions, and the network entity 105-a may configure the UE 115-a to use a specific periodicity or triggering condition via DCI or a MAC CE.

Upon receiving the BFD report 230 from the UE 115-a (e.g., via the UE 115-b), the network entity 105-a may, in some examples, initiate a beam switch to reduce the likelihood of a beam failure occurring between the UE 115-a and the network entity 105-a. The network entity 105-a may initiate the beam switch by transmitting a beam switch command 235-a to the UE 115-a over a Uu link. Additionally or alternatively, the network entity 105-a may transmit a beam switch command 235-b to the UE 115-b (e.g., over a Uu link), and the UE 115-b may forward (e.g., relay) the beam switch command 235-b to the UE 115-a over a PC5 interface (e.g., a sidelink connection).

The network entity 105-a may transmit the beam switch commands 235 based on a BFI count in the BFD report 230, channel condition measurements in the BFD report 230, a BFI reporting history indicated by the BFD report 230, or a combination thereof. For example, if a BFI count in the BFD report 230 is above a specific percentage (e.g., x %) of a threshold (e.g., maxCount), the network entity 105-a may initiate a downlink beam switching procedure. The beam switch commands 235 may be signaled via DCI or a MAC-CE. In some examples, the network entity 105-a may also transmit reference signals 225 (e.g., additional aperiodic BFD-RSs) to confirm a beam quality of the UE 115-a. The reference signals 225 may enable the UE 115-a to measure and report beam quality information with reduced latency and greater accuracy. Upon receiving this information, the network entity 105-a may determine whether to initiate beam switching (e.g., to mitigate potential beam failures).

BFD reporting can be activated or deactivated in both uplink and downlink directions. For example, the network entity 105-a may transmit a control message 220 (e.g., an activation or deactivation signal) to the UE 115-a. The control message 220 may activate (or deactivate) BFD reporting at the UE 115-a in accordance with a specific configuration. Alternatively, the control message 220 may indicate that the UE 115-a is to switch from a first BFD reporting configuration to a second BFD reporting configuration. The network entity 105-a may indicate the control message 220 via DCI or a MAC-CE. Additionally or alternatively, the UE 115-a may transmit an activation request 215 to the network entity 105-a. The activation request 215 may also activate (or deactivate) BFD reporting at the UE 115-a in accordance with a specific configuration.

In some examples, the network entity 105-a may transmit the control message 220 based on a number of activation or deactivation factors, which may include a QoS threshold of serving traffic, discontinuous reception (DRX) configuration settings of the UE 115-a (e.g., a DRX cycle length of the UE 115-a, a DRX ON duration of the UE 115-a, a DRX OFF duration of the UE 115-a), capabilities of the UE 115-a (e.g., power constraints), or a combination thereof. Configuring the UE 115-a (e.g., a source UE) to transmit the BFD report 230 to the network entity 105-a via the UE 115-b (e.g., a relay UE) may have a nominal effect on Uu link data loading. Moreover, configuring the UE 115-a to provide the network entity 105-a with frequent BFD status updates may enable the UE 115-a to mitigate or avoid potential beam failures. As such, the techniques described herein may enable the UE 115-a to experience greater power savings, reduced latency, and higher overall service quality (e.g., due to the increased reliability of communications between the UE 115-a and the network entity 105-a).

The wireless communications system 200 may support techniques for improving the reliability of communications between the UE 115-a and the network entity 105-a by reducing the likelihood of beam failures occurring between the UE 115-a and the network entity 105-a. More specifically, the techniques and operations described with reference to FIG. 2 may enable the network entity 105-a to receive BFD reports from the UE 115-a via the UE 115-b (e.g., a relay device), which may enable the network entity 105-a to more effectively detect and mitigate beam failures between the UE 115-a and the network entity 105-a. Moreover, the described techniques may reduce a number of BFR procedures performed by the UE 115-a, which may result in reduced power consumption and decreased latency at the UE 115-a, among other benefits.

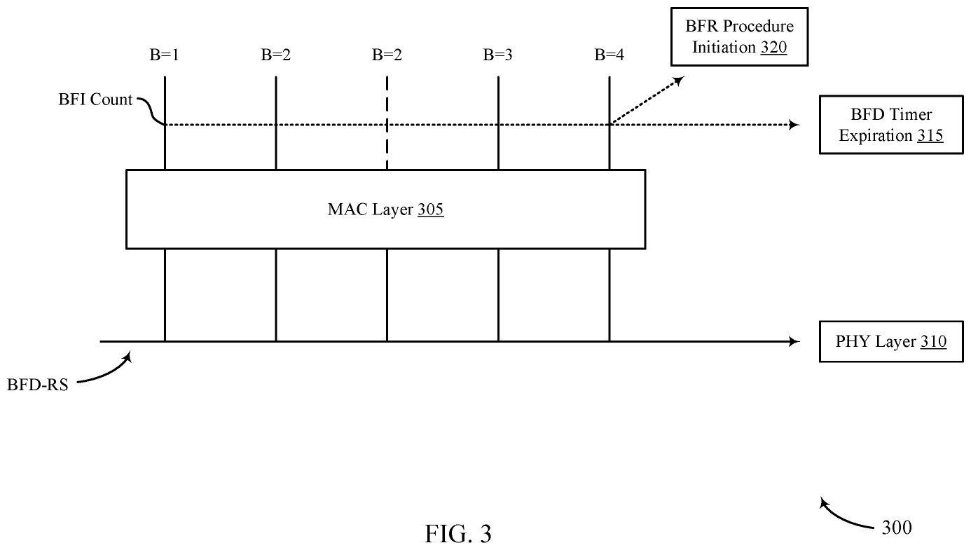

FIG. 3 illustrates an example of a BFD procedure 300 that supports relaying BFD reports in accordance with one or more aspects of the present disclosure. The BFD procedure 300 may implement or be implemented by aspects of the wireless communications system 100 or the wireless communications system 200. For example, the BFD procedure may be implemented by a UE, which may be an example of a UE 115 described with reference to FIGS. 1 and 2. In the example of FIG. 3, a UE may declare beam failure and initiate a BFR procedure if a BFI count exceeds a threshold prior to expiration of a BFD timer.

The BFD procedure 300 may enable a UE to detect and mitigate beam failures that occur between the UE and a network entity. For example, a PHY layer 310 of the UE may monitor periodic BFD-RS from the network entity, which may include CSI-RSs or synchronization signal blocks (SSBs). Accordingly, the UE may determine BFIs at each BFD-RS monitoring occasion. The UE may start a BFD timer after the first indication of a BFI. With each subsequent BFI indication, a MAC layer 305 of the UE may increment a BFI count (e.g., B) by 1. If, for example, a total BFI count of the UE exceeds a threshold (e.g., maxCount) before the BFD timer expires, the UE may declare beam failure and initiate a BFR procedure at 320. Otherwise, if the BFD timer expires at 315 before the total BFI count exceeds the threshold, the UE may reset the total BFI count to 0 and restart the BFD timer.

As described with reference to FIGS. 1 and 2, the UE may be configured to provide the network entity with a BFD report prior to declaring beam failure and initiating a BFR procedure at 320. This BFD report may include information pertaining to a BFD status of the UE (e.g., a current beam identifier, a BFI count, a set of channel measurements), which the network entity may use to identify and mitigate beam failures. Configuring the UE to provide the network entity with BFD reports prior to declaring beam failure may reduce the number of BFR procedures performed by the UE, which may result in greater power savings, decreased latency, and more reliable communications between the UE and the network entity.

In some examples, the UE may be configured to transmit the BFD report to the network entity via a relay device that is connected to the UE and the network entity. For example, the UE may transmit a BFD report to the relay device over a sidelink channel, and the relay device may forward the BFD report to the network entity over an uplink channel. To support the techniques described herein, the UE may receive control signaling indicating a configuration for reporting (e.g., transmitting) BFD reports to the network entity via the relay device. This configuration may indicate, for example, a BFD reporting periodicity (e.g., for periodic BFD reports) or a set of BFD reporting trigger conditions (e.g., for aperiodic BFD reports).

The BFD procedure 300 may support techniques for improving the reliability of communications between a UE and a network entity by reducing the likelihood of beam failures occurring between the UE and the network entity. More specifically, the techniques and operations described with reference to FIG. 3 may enable a network entity to receive BFD reports from a UE via a relay device, which may enable the network entity to more effectively detect and mitigate beam failures between the UE and the network entity. Moreover, the described techniques may reduce a number of BFR procedures performed by the UE, which may result in reduced power consumption and decreased latency at the UE, among other benefits.

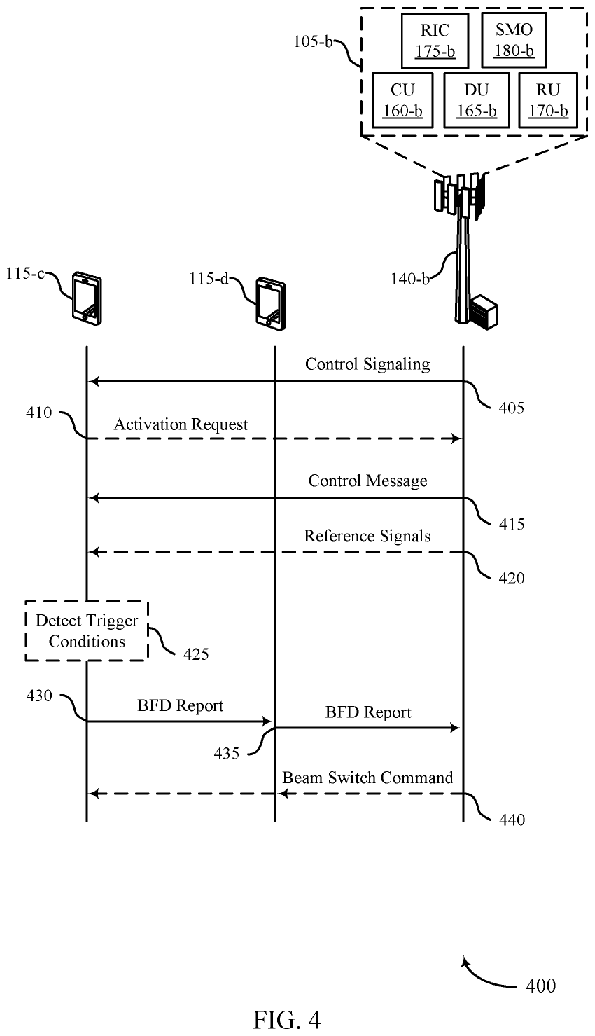

FIG. 4 illustrates an example of a process flow 400 that supports relaying BFD reports in accordance with one or more aspects of the present disclosure. The process flow 400 may implement or be implemented by aspects of the wireless communications system 100 or the wireless communications system 200. For example, the process flow 400 may include a UE 115-c, a UE 115-d, and a network entity 105-b, which may be examples of corresponding devices described with reference to FIGS. 1 and 2. In the following description of the process flow 400, operations between the UEs 115 and the network entity 105-b may be performed in a different order or at a different time than as shown. Additionally or alternatively, some operations may be omitted from the process flow 400, and other operations may be added to the process flow 400.

As described with reference to FIGS. 1 and 2, the network entity 105-b may include an RIC 175-b, a SMO 180-b, a CU 160-b, a DU 165-b, an RU 170-b, a base station 140-b, or a combination thereof. Communications between the network entity 105-b and the UEs 115 may refer to communications between the UEs 115 and any portion (e.g., entity, sub-entity) of the network entity 105-b. In the following description of the process flow 400, the terms “transmitting,” “receiving,” or “communicating,” when referring to the network entity 105-b, may refer to any portion of the network entity 105-b (e.g., the base station 140-b, the CU 160-b, the DU 165-b, the RU 170-b) communicating with the UEs 115 (e.g., directly or via one or more other network entities 105).

At 405, the UE 115-c may receive control signaling indicating a configuration for relaying BFD reports via the UE 115-d (e.g., a relay device). In some examples, the control signaling may indicate multiple BFD reporting configurations for the UE 115-c. The control signaling may also indicate a periodicity for relaying periodic BFD reports via the UE 115-d. Additionally or alternatively, the control signaling may indicate one or more trigger conditions for relaying aperiodic BFD reports via the UE 115-d. These trigger conditions may be based on a quantity of consecutive BFIs exceeding a threshold, a total quantity of BFIs exceeding a threshold percentage of a parameter (e.g., maxCount), a change in channel strength exceeding a threshold value, or a combination thereof. In some examples, the control signaling may include RRC signaling or system information.

In some examples, the UE 115-c may transmit a request to activate BFD reporting at 410. The UE 115-c may include the request in a MAC-CE or an instance of UCI. At 415, the network entity 105-b may transmit a control message activating BFD reporting at the UE 115-c in accordance with the configuration. In some examples, the network entity 105-b may transmit the control message in response to the request from the UE 115-c. Additionally or alternatively, the network entity 105-b may transmit the control message based on a QoS threshold of the UE 115-c, a DRX configuration of the UE 115-c, a DRX cycle length of the UE 115-c, an active DRX duration of the UE 115-c, an inactive DRX duration of the UE 115-c, a capability of the UE 115-c, or a combination thereof.

If, for example, the UE 115-c is configured with multiple BFD reporting configurations, the control message may indicate (e.g., activate) one of these configurations. Alternatively, if the UE 115-c is currently relaying BFD reports to the network entity 105-b in accordance with a first BFD reporting configuration, the control message may indicate that the UE 115-c is to switch from the first BFD reporting configuration to a second BFD reporting configuration. In some examples, the network entity 105-b may include (e.g., embed) the control message in a MAC-CE or an instance of DCI.

At 420, the UE 115-c may monitor for one or more BFD-RSs (e.g., CSI-RSs, SSBs) from the network entity 105-b, and may determine one or more BFIs based on a result of the monitoring. As described herein, the BFIs may pertain to communications between the UE 115-c and the network entity 105-b. In some examples, the UE 115-c may determine (e.g., based on monitoring for the BFD-RSs) that one or more trigger conditions have been satisfied at 425. For example, the UE 115-c may determine that a quantity of consecutive BFIs has exceeded a threshold or that a total quantity of BFIs has exceeded a threshold percentage of a parameter (e.g., maxCount).

At 430, the UE 115-c may transmit a BFD report to the UE 115-d. The UE 115-c may indicate the BFD report via a sidelink MAC-CE. Accordingly, the UE 115-d may relay the BFD report to the network entity 105-b at 435 (e.g., via a MAC-CE or an instance of UCI). The UE 115-c may transmit the BFD report prior to a beam failure declaration, which may occur when a quantity of BFIs exceeds a threshold prior to expiration of a BFD timer. The BFD report may be an example of a periodic BFD report or an aperiodic BFD report. For example, the UE 115-c may transmit a periodic BFD report to the UE 115-d in accordance with a BFD reporting periodicity specified by the network entity 105-a. Similarly, the UE 115-c may transmit an aperiodic report to the UE 115-d in response to determining that one or more trigger conditions have been satisfied. The BFD report may indicate a current beam of the UE 115-c, a spatial relationship between the current beam of the UE 115-c and the network entity 105-b, a BFI count, a BFI record history, a set of channel measurements (e.g., SINR, RSRP, pathloss, interference), an identifier of the UE 115-c, or a combination thereof.

In some examples, the network entity 105-b may transmit a beam switch command to the UE 115-c at 440. The network entity 105-b may transmit the beam switch command based on information provided by the BFD report. For example, the network entity 105-b may transmit the beam switch command based on a BFI count indicated by the BFD report, a BFI report history indicated by the BFD report, a set of channel measurements indicated by the BFD report, or a combination thereof. The beam switch command may indicate a new beam for the UE 115-c to use when communicating with the network entity 105-b.

The network entity 105-b may indicate the beam switch command via a MAC-CE or an instance of DCI. In some examples, the network entity 105-b may transmit the beam switch command directly to the UE 115-c (e.g., over a Uu interface). In other examples, the network entity 105-b may relay the beam switch command to the UE 115-c via the UE 115-d (e.g., over a PC5 interface). Additionally or alternatively, the network entity 105-b may transmit one or more additional BFD-RSs based on the BFD report (e.g., to confirm a beam quality of the UE 115-c).

The process flow 400 may support techniques for improving the reliability of communications between the UE 115-c and the network entity 105-b by reducing the likelihood of beam failures occurring between the UE 115-c and the network entity 105-b. More specifically, the techniques and operations described with reference to FIG. 4 may enable the network entity 105-b to receive BFD reports from the UE 115-c via the UE 115-d (e.g., a relay device), which may enable the network entity 105-b to more effectively detect and mitigate beam failures between the UE 115-c and the network entity 105-b. Moreover, the described techniques may reduce a number of BFR procedures performed by the UE 115-c, which may result in reduced power consumption and decreased latency at the UE 115-c, among other benefits.

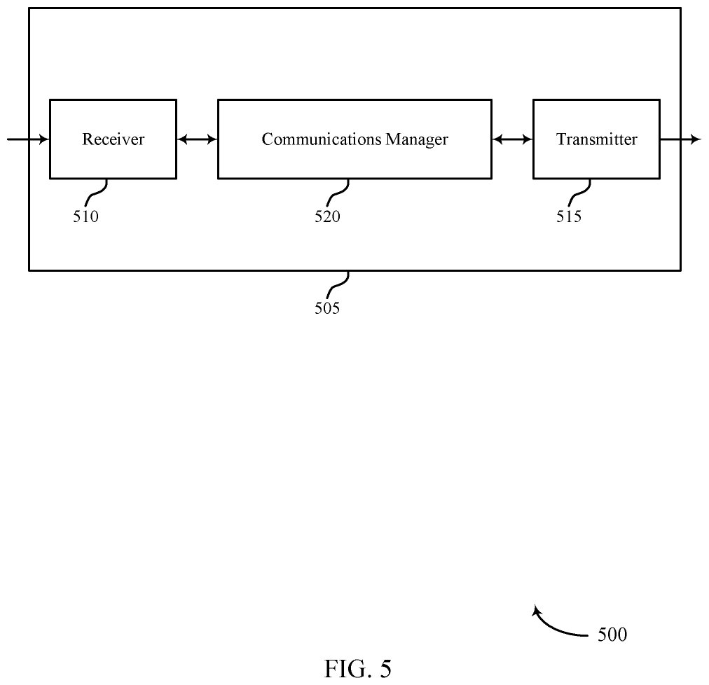

FIG. 5 shows a block diagram 500 of a device 505 that supports relaying BFD reports in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to relaying BFD reports). Information may be passed on to other components of the device 505. The receiver 510 may utilize a single antenna or multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to relaying BFD reports). In some examples, the transmitter 515 may be co-located with a receiver 510 in a transceiver module. The transmitter 515 may utilize a single antenna or multiple antennas.

The communications manager 520, the receiver 510, the transmitter 515, or various combinations thereof or various components thereof may be examples of means for performing various aspects of relaying BFD reports as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at the device 505 (e.g., a UE 115) in accordance with examples disclosed herein. For example, the communications manager 520 may be configured as or otherwise support a means for receiving control signaling indicating a configuration for reporting, via a relay device, one or more BFD reports. The communications manager 520 may be configured as or otherwise support a means for receiving a control message activating BFD reporting at the device 505 in accordance with the configuration. The communications manager 520 may be configured as or otherwise support a means for monitoring for one or more reference signals from a network entity to determine one or more BFIs with respect to communications between the device 505 and the network entity. The communications manager 520 may be configured as or otherwise support a means for transmitting, via the relay device and in accordance with the configuration, a BFD report prior to a beam failure declaration by the device 505, where the beam failure declaration is based on a quantity of the one or more BFIs exceeding a threshold.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced power consumption by relaying BFD reports to a network entity prior to detecting a beam failure. By providing the network entity with BFD status information prior to a beam failure declaration, the device 505 may perform fewer BFR procedures, which may reduce power consumption at the device 505.

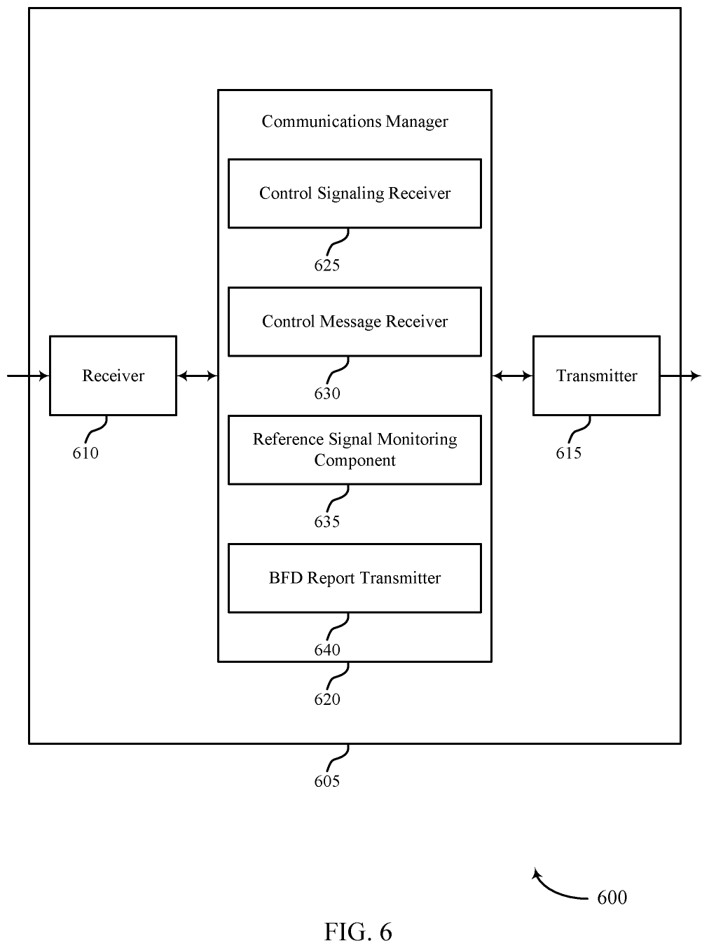

FIG. 6 shows a block diagram 600 of a device 605 that supports relaying BFD reports in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to relaying BFD reports). Information may be passed on to other components of the device 605. The receiver 610 may utilize a single antenna or multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to relaying BFD reports). In some examples, the transmitter 615 may be co-located with a receiver 610 in a transceiver module. The transmitter 615 may utilize a single antenna or multiple antennas.

The device 605, or various components thereof, may be an example of means for performing various aspects of relaying BFD reports as described herein. For example, the communications manager 620 may include a control signaling receiver 625, a control message receiver 630, a reference signal monitoring component 635, an BFD report transmitter 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at the device 605 (e.g., a UE 115) in accordance with examples disclosed herein. The control signaling receiver 625 may be configured as or otherwise support a means for receiving control signaling indicating a configuration for reporting, via a relay device, one or more BFD reports. The control message receiver 630 may be configured as or otherwise support a means for receiving a control message activating BFD reporting at the device 605 in accordance with the configuration. The reference signal monitoring component 635 may be configured as or otherwise support a means for monitoring for one or more reference signals from a network entity to determine one or more BFIs with respect to communications between the device 605 and the network entity. The BFD report transmitter 640 may be configured as or otherwise support a means for transmitting, via the relay device and in accordance with the configuration, a BFD report prior to a beam failure declaration by the device 605, where the beam failure declaration is based on a quantity of the one or more BFIs exceeding a threshold.

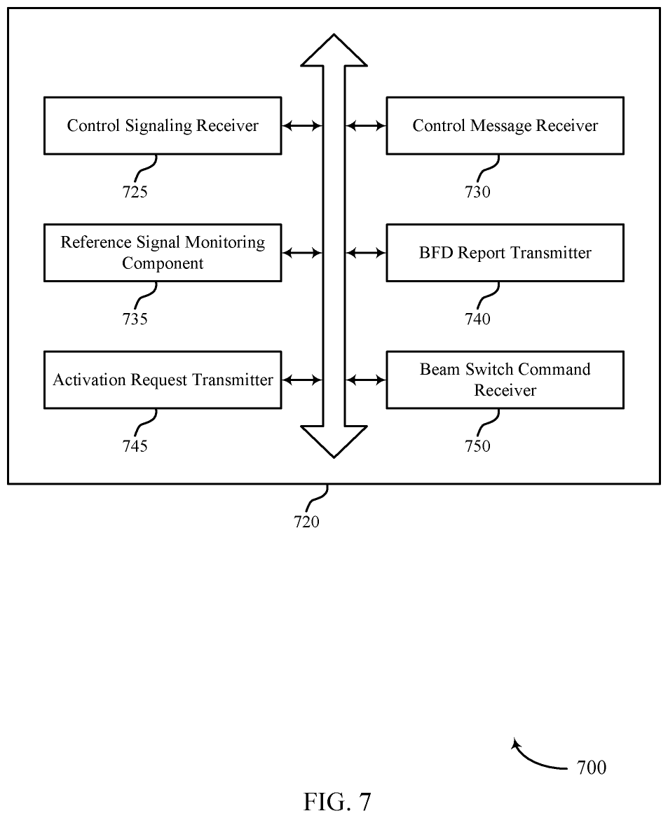

FIG. 7 shows a block diagram 700 of a communications manager 720 that supports relaying BFD reports in accordance with one or more aspects of the present disclosure. The communications manager 720 may be an example of aspects of a communications manager 520, a communications manager 620, or both, as described herein. The communications manager 720, or various components thereof, may be an example of means for performing various aspects of relaying BFD reports as described herein. For example, the communications manager 720 may include a control signaling receiver 725, a control message receiver 730, a reference signal monitoring component 735, an BFD report transmitter 740, an activation request transmitter 745, a beam switch command receiver 750, or any combination thereof. Each of these components may communicate, directly or indirectly, with one another (e.g., via one or more buses).

The communications manager 720 may support wireless communications at a UE in accordance with examples disclosed herein. The control signaling receiver 725 may be configured as or otherwise support a means for receiving control signaling indicating a configuration for reporting, via a relay device, one or more BFD reports. The control message receiver 730 may be configured as or otherwise support a means for receiving a control message activating BFD reporting at the UE in accordance with the configuration. The reference signal monitoring component 735 may be configured as or otherwise support a means for monitoring for one or more reference signals from a network entity to determine one or more BFIs with respect to communications between the UE and the network entity. The BFD report transmitter 740 may be configured as or otherwise support a means for transmitting, via the relay device and in accordance with the configuration, a BFD report prior to a beam failure declaration by the UE, where the beam failure declaration is based on a quantity of the one or more BFIs exceeding a threshold.

In some examples, to support receiving the control signaling, the control signaling receiver 725 may be configured as or otherwise support a means for receiving, as part of the control signaling, information indicative of a periodicity for reporting, via the relay device, one or more BFD reports, where transmitting the BFD report is based on the periodicity. In some examples, to support transmitting the BFD report, the BFD report transmitter 740 may be configured as or otherwise support a means for transmitting an aperiodic BFD report based on determining that one or more trigger conditions have been satisfied. In some examples, to support receiving the control signaling, the control signaling receiver 725 may be configured as or otherwise support a means for receiving, as part of the control signaling, information indicative of the one or more trigger conditions for reporting, via the relay device, one or more aperiodic BFD reports. In some examples, the one or more trigger conditions are based on a quantity of consecutive BFIs exceeding a threshold, a total quantity of BFIs exceeding a threshold percentage of a parameter, a change in channel strength exceeding a threshold, or a combination thereof.

In some examples, to support transmitting the BFD report, the BFD report transmitter 740 may be configured as or otherwise support a means for transmitting, as part of the BFD report, information indicative of a beam identifier, a spatial relationship between the beam identifier and the network entity, a BFI count associated with the one or more BFIs, a BFI record log, a set of channel measurements, an identifier of the UE, or a combination thereof. In some examples, the set of channel measurements includes a SINR, an RSRP measurement, a pathloss measurement, an interference value, or a combination thereof. In some examples, to support receiving the control signaling, the control signaling receiver 725 may be configured as or otherwise support a means for receiving information indicative of multiple configurations for reporting, via the relay device, one or more BFD reports.

In some examples, to support receiving the control message, the control message receiver 730 may be configured as or otherwise support a means for receiving an indication that BFD reporting is activated at the UE in accordance with a first configuration of the multiple configurations. In some examples, the control message receiver 730 may be configured as or otherwise support a means for receiving one or both of a MAC-CE or DCI indicating that the UE is to switch from a first configuration of the multiple configurations to a second configuration of the multiple configurations.

In some examples, the activation request transmitter 745 may be configured as or otherwise support a means for transmitting a request to activate BFD reporting at the UE, where receiving the control message is based on transmitting the request. In some examples, to support transmitting the request, the activation request transmitter 745 may be configured as or otherwise support a means for transmitting one or both of a MAC-CE or UCI indicating the request to activate BFD reporting at the UE.

In some examples, the beam switch command receiver 750 may be configured as or otherwise support a means for receiving a beam switch command based on transmitting the BFD report. In some examples, to support receiving the beam switch command, the beam switch command receiver 750 may be configured as or otherwise support a means for receiving one or both of a MAC-CE or DCI indicating the beam switch command.

In some examples, the reference signal monitoring component 735 may be configured as or otherwise support a means for monitoring for a set of reference signals from the network entity based on transmitting the BFD report. In some examples, to support transmitting the BFD report, the BFD report transmitter 740 may be configured as or otherwise support a means for transmitting, via the relay device and in accordance with the configuration, a sidelink MAC-CE including the BFD report.

In some examples, to support receiving the control signaling, the control signaling receiver 725 may be configured as or otherwise support a means for receiving RRC signaling indicating the configuration for reporting, via the relay device, one or more BFD reports. In some examples, to support receiving the control message, the control message receiver 730 may be configured as or otherwise support a means for receiving one or both of a MAC-CE or DCI activating BFD reporting at the UE in accordance with the configuration.

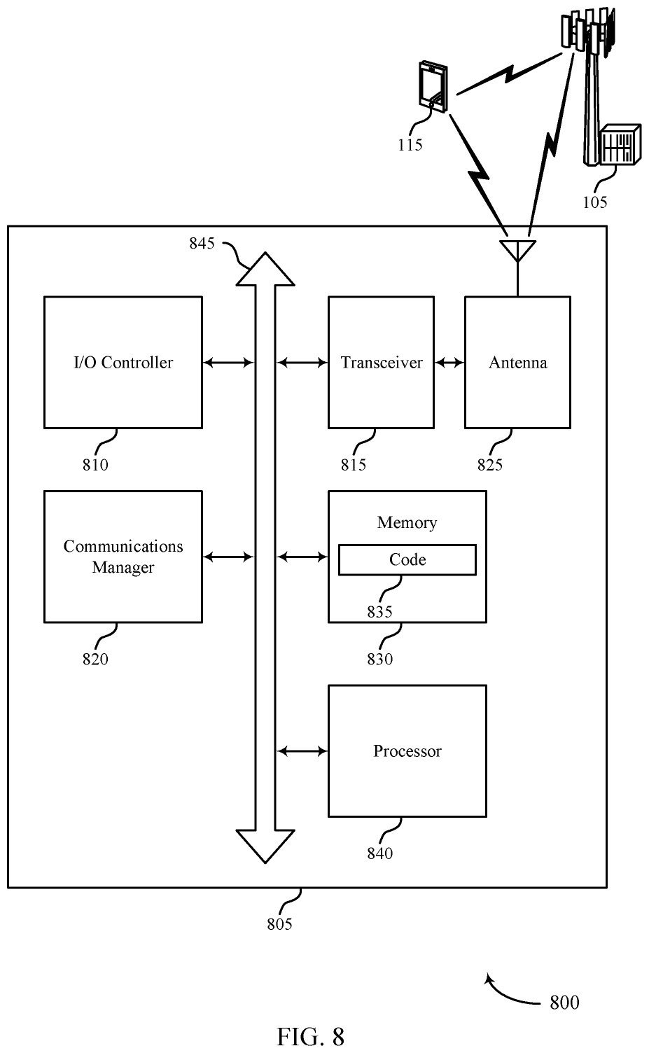

FIG. 8 shows a diagram of a system 800 including a device 805 that supports relaying BFD reports in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting relaying BFD reports). For example, the device 805 or a component of the device 805 may include a processor 840 and memory 830 coupled with or to the processor 840, the processor 840 and memory 830 configured to perform various functions described herein.

The communications manager 820 may support wireless communications at the device 805 (e.g., a UE 115) in accordance with examples disclosed herein. For example, the communications manager 820 may be configured as or otherwise support a means for receiving control signaling indicating a configuration for reporting, via a relay device, one or more BFD reports. The communications manager 820 may be configured as or otherwise support a means for receiving a control message activating BFD reporting at the device 805 in accordance with the configuration. The communications manager 820 may be configured as or otherwise support a means for monitoring for one or more reference signals from a network entity to determine one or more BFIs with respect to communications between the device 805 and the network entity. The communications manager 820 may be configured as or otherwise support a means for transmitting, via the relay device and in accordance with the configuration, a BFD report prior to a beam failure declaration by the device 805, where the beam failure declaration is based on a quantity of the one or more BFIs exceeding a threshold.

By including or configuring the communications manager 820 in accordance with examples as described herein, the device 805 may support techniques for improved communication reliability and reduced latency by decreasing the likelihood of beam failures occurring between the device 805 and a network entity. More specifically, the techniques and operations described herein may enable the device 805 to transmit BFD reports to a network entity via a relay device, which may enable the device 805 to more effectively detect and mitigate beam failures between the device 805 and the network entity. Moreover, the described techniques may reduce a number of BFR procedures performed by the device 805, which may result in reduced latency at the device 805.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of relaying BFD reports as described herein, or the processor 840 and the memory 830 may be otherwise configured to perform or support such operations.

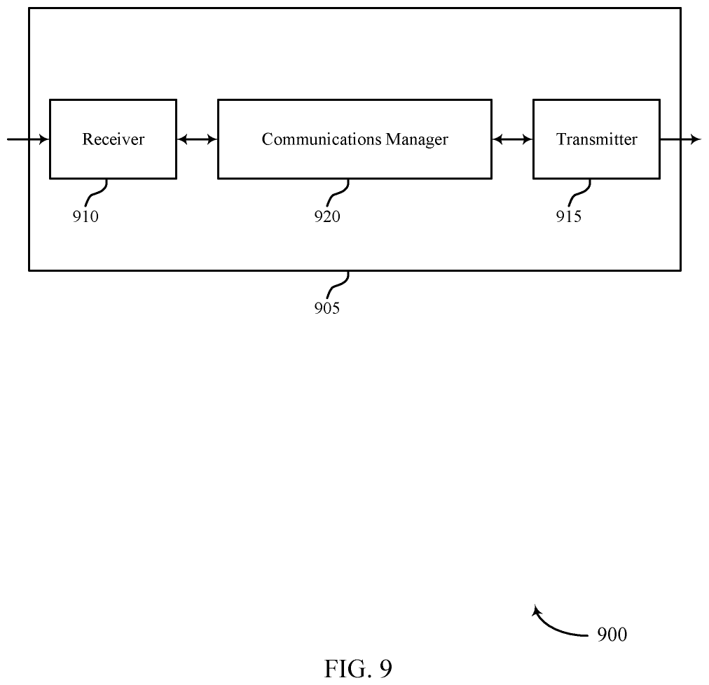

FIG. 9 shows a block diagram 900 of a device 905 that supports relaying BFD reports in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of relaying BFD reports as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at the device 905 (e.g., a network entity 105) in accordance with examples disclosed herein. For example, the communications manager 920 may be configured as or otherwise support a means for transmitting control signaling indicating a configuration for reporting, by a UE and via a relay device, one or more BFD reports. The communications manager 920 may be configured as or otherwise support a means for transmitting a control message activating BFD reporting at the UE in accordance with the configuration. The communications manager 920 may be configured as or otherwise support a means for transmitting one or more reference signals. The communications manager 920 may be configured as or otherwise support a means for receiving, via the relay device and in accordance with the configuration, a BFD report for the UE.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced power consumption by configuring a UE to relay BFD reports to the device 905 prior to a beam failure declaration. Configuring the UE to provide BFD status information before a beam failure is detected may reduce the number of BFR procedures performed by the device 905, which may reduce power consumption at the device 905.

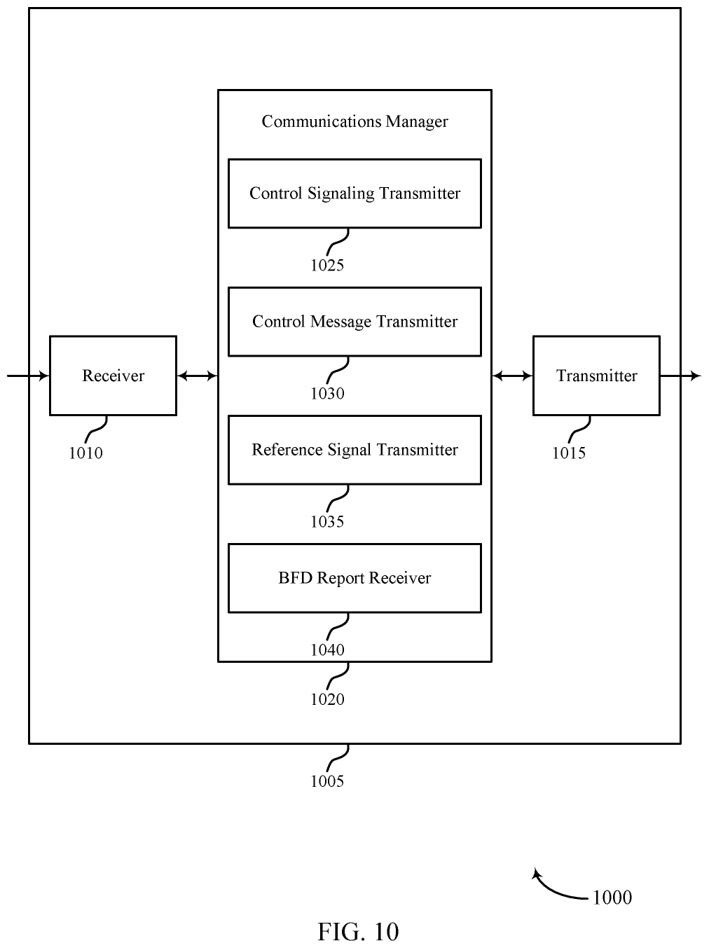

FIG. 10 shows a block diagram 1000 of a device 1005 that supports relaying BFD reports in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of relaying BFD reports as described herein. For example, the communications manager 1020 may include a control signaling transmitter 1025, a control message transmitter 1030, a reference signal transmitter 1035, an BFD report receiver 1040, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at the device 1005 (e.g., a network entity 105) in accordance with examples disclosed herein. The control signaling transmitter 1025 may be configured as or otherwise support a means for transmitting control signaling indicating a configuration for reporting, by a UE and via a relay device, one or more BFD reports. The control message transmitter 1030 may be configured as or otherwise support a means for transmitting a control message activating BFD reporting at the UE in accordance with the configuration. The reference signal transmitter 1035 may be configured as or otherwise support a means for transmitting one or more reference signals. The BFD report receiver 1040 may be configured as or otherwise support a means for receiving, via the relay device and in accordance with the configuration, a BFD report for the UE.

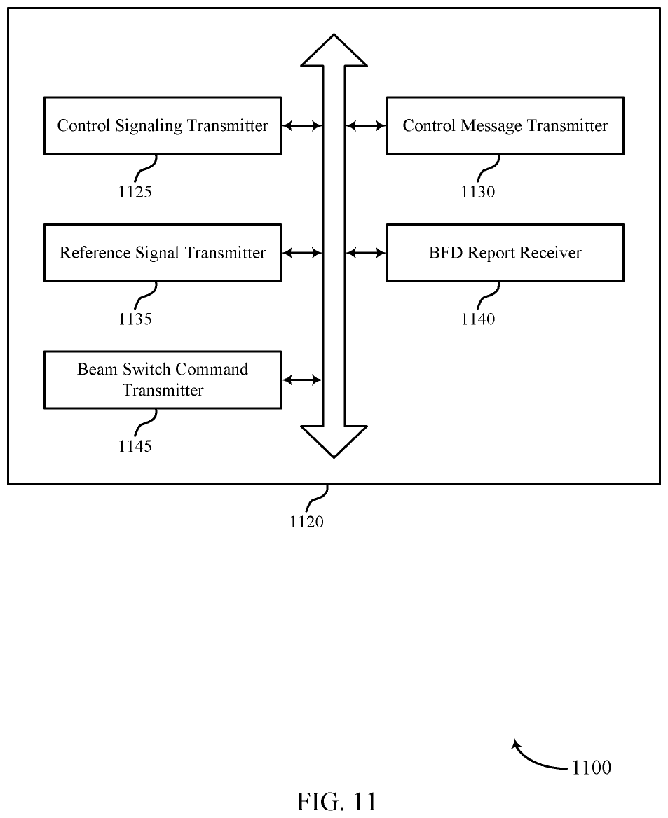

FIG. 11 shows a block diagram 1100 of a communications manager 1120 that supports relaying BFD reports in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of relaying BFD reports as described herein. For example, the communications manager 1120 may include a control signaling transmitter 1125, a control message transmitter 1130, a reference signal transmitter 1135, an BFD report receiver 1140, a beam switch command transmitter 1145, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity in accordance with examples disclosed herein. The control signaling transmitter 1125 may be configured as or otherwise support a means for transmitting control signaling indicating a configuration for reporting, by a UE and via a relay device, one or more BFD reports. The control message transmitter 1130 may be configured as or otherwise support a means for transmitting a control message activating BFD reporting at the UE in accordance with the configuration. The reference signal transmitter 1135 may be configured as or otherwise support a means for transmitting one or more reference signals. The BFD report receiver 1140 may be configured as or otherwise support a means for receiving, via the relay device and in accordance with the configuration, a BFD report for the UE.

In some examples, to support transmitting the control signaling, the control signaling transmitter 1125 may be configured as or otherwise support a means for transmitting, as part of the control signaling, information indicative of a periodicity for the UE to report, via the relay device, one or more BFD reports, where receiving the BFD report is based on the periodicity. In some examples, to support transmitting the control signaling, the control signaling transmitter 1125 may be configured as or otherwise support a means for transmitting, as part of the control signaling, information indicative of one or more trigger conditions for the UE to report, via the relay device, one or more aperiodic BFD reports. In some examples, the one or more trigger conditions are based on a quantity of consecutive BFIs exceeding a threshold, a total quantity of BFIs exceeding a threshold percentage of a parameter, a change in channel strength exceeding a threshold, or a combination thereof.

In some examples, to support receiving the BFD report, the BFD report receiver 1140 may be configured as or otherwise support a means for receiving, as part of the BFD report, information indicative of a beam identifier, a spatial relationship between the beam identifier and the network entity, a BFI count, a BFI record log, a set of channel measurements, an identifier of the UE, or a combination thereof.

In some examples, the beam switch command transmitter 1145 may be configured as or otherwise support a means for transmitting a beam switch command for the UE based on receiving the BFD report. In some examples, to support transmitting the beam switch command, the beam switch command transmitter 1145 may be configured as or otherwise support a means for transmitting the beam switch command for the UE based on a BFI count indicated by the BFD report, a set of channel measurements indicated by the BFD report, a BFI reporting log indicated by the BFD report, a BFI count threshold, or a combination thereof.

In some examples, to support transmitting the control message, the control message transmitter 1130 may be configured as or otherwise support a means for transmitting the control message activating beam failure reporting at the UE based on a QoS threshold, a DRX configuration of the UE, a DRX cycle length of the UE, an active DRX duration of the UE, an inactive DRX duration of the UE, a capability of the UE, or a combination thereof.

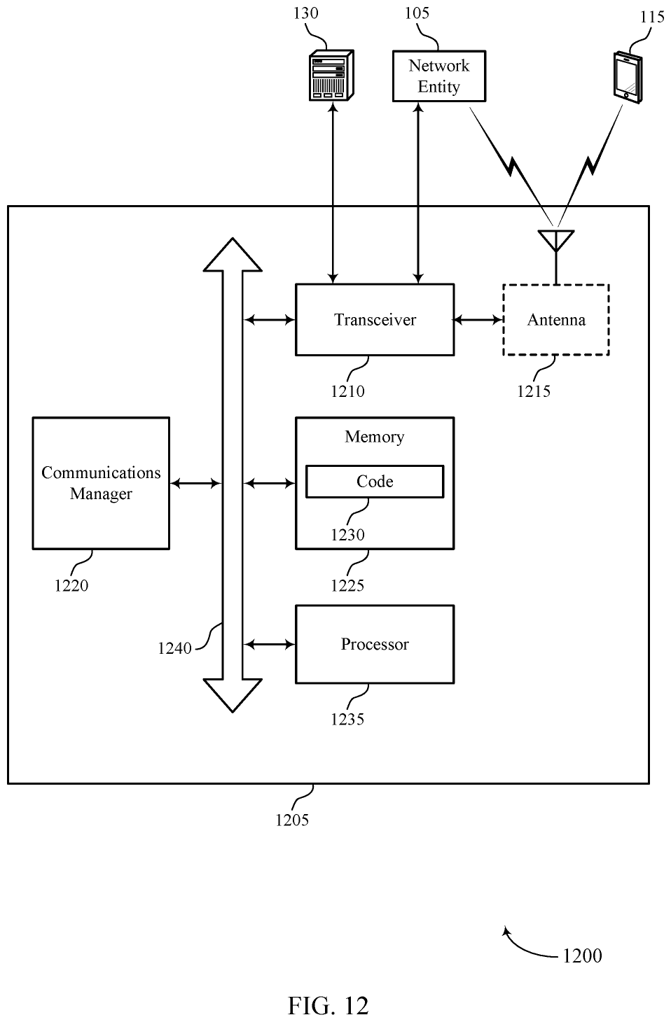

FIG. 12 shows a diagram of a system 1200 including a device 1205 that supports relaying BFD reports in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. The transceiver 1210, or the transceiver 1210 and one or more antennas 1215 or wired interfaces, where applicable, may be an example of a transmitter 915, a transmitter 1015, a receiver 910, a receiver 1010, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting relaying BFD reports). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at the device 1205 (e.g., a network entity 105) in accordance with examples disclosed herein. For example, the communications manager 1220 may be configured as or otherwise support a means for transmitting control signaling indicating a configuration for reporting, by a UE and via a relay device, one or more BFD reports. The communications manager 1220 may be configured as or otherwise support a means for transmitting a control message activating BFD reporting at the UE in accordance with the configuration. The communications manager 1220 may be configured as or otherwise support a means for transmitting one or more reference signals. The communications manager 1220 may be configured as or otherwise support a means for receiving, via the relay device and in accordance with the configuration, a BFD report for the UE.

By including or configuring the communications manager 1220 in accordance with examples as described herein, the device 1205 may support techniques for improved communication reliability and reduced latency by decreasing the likelihood of beam failures occurring between the device 1205 and a UE. More specifically, the techniques and operations described herein may enable the device 1205 to receive BFD reports from a UE via a relay device, which may enable the device 1205 to more effectively detect and mitigate beam failures between the device 1205 and the UE. Moreover, the described techniques may reduce a number of BFR procedures performed by the device 1205, which may result in reduced latency at the device 1205.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the processor 1235, the memory 1225, the code 1230, the transceiver 1210, or any combination thereof. For example, the code 1230 may include instructions executable by the processor 1235 to cause the device 1205 to perform various aspects of relaying BFD reports as described herein, or the processor 1235 and the memory 1225 may be otherwise configured to perform or support such operations.

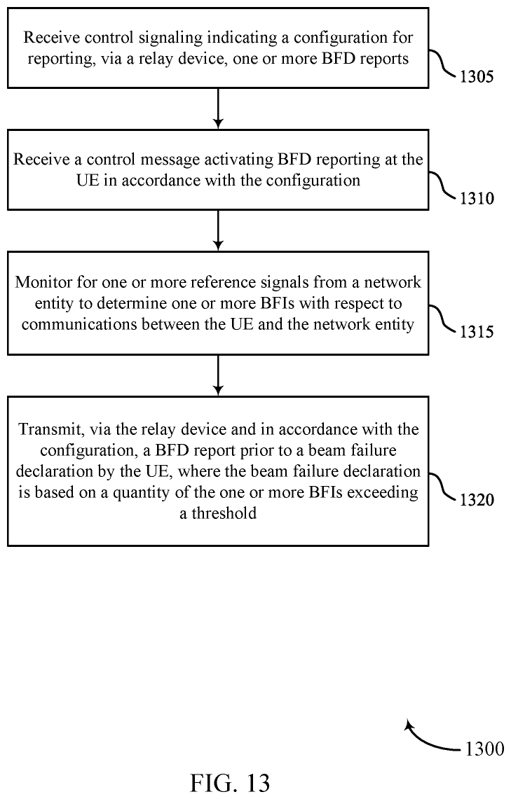

FIG. 13 shows a flowchart illustrating a method 1300 that supports relaying BFD reports in accordance with one or more aspects of the present disclosure. The operations of the method 1300 may be implemented by a UE or various components of a UE, as described herein. For example, the operations of the method 1300 may be performed by a UE 115, as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving control signaling indicating a configuration for reporting, via a relay device, one or more BFD reports. The operations of 1305 may be performed in accordance with examples disclosed herein. In some examples, aspects of the operations of 1305 may be performed by a control signaling receiver 725, as described with reference to FIG. 7.

At 1310, the method may include receiving a control message activating BFD reporting at the UE in accordance with the configuration. The operations of 1310 may be performed in accordance with examples disclosed herein. In some examples, aspects of the operations of 1310 may be performed by a control message receiver 730, as described with reference to FIG. 7.

At 1315, the method may include monitoring for one or more reference signals from a network entity to determine one or more BFIs with respect to communications between the UE and the network entity. The operations of 1315 may be performed in accordance with examples disclosed herein. In some examples, aspects of the operations of 1315 may be performed by a reference signal monitoring component 735, as described with reference to FIG. 7.

At 1320, the method may include transmitting, via the relay device and in accordance with the configuration, a BFD report prior to a beam failure declaration by the UE, where the beam failure declaration is based on a quantity of the one or more BFIs exceeding a threshold. The operations of 1320 may be performed in accordance with examples disclosed herein. In some examples, aspects of the operations of 1320 may be performed by an BFD report transmitter 740, as described with reference to FIG. 7.

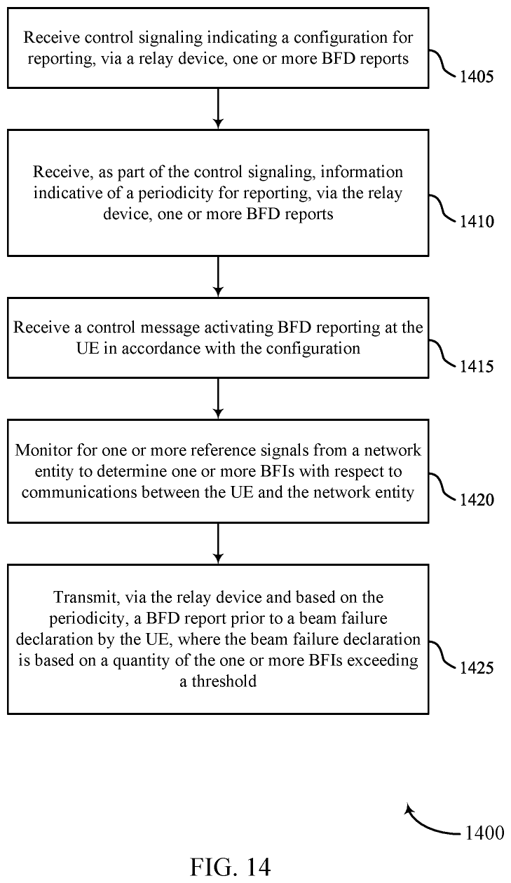

FIG. 14 shows a flowchart illustrating a method 1400 that supports relaying BFD reports in accordance with one or more aspects of the present disclosure. The operations of the method 1400 may be implemented by a UE or various components of a UE, as described herein. For example, the operations of the method 1400 may be performed by a UE 115, as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving control signaling indicating a configuration for reporting, via a relay device, one or more BFD reports. The operations of 1405 may be performed in accordance with examples disclosed herein. In some examples, aspects of the operations of 1405 may be performed by a control signaling receiver 725, as described with reference to FIG. 7.

At 1410, the method may include receiving, as part of the control signaling, information indicative of a periodicity for reporting, via the relay device, one or more BFD reports. The operations of 1410 may be performed in accordance with examples disclosed herein. In some examples, aspects of the operations of 1410 may be performed by a control signaling receiver 725, as described with reference to FIG. 7.

At 1415, the method may include receiving a control message activating BFD reporting at the UE in accordance with the configuration. The operations of 1415 may be performed in accordance with examples disclosed herein. In some examples, aspects of the operations of 1415 may be performed by a control message receiver 730, as described with reference to FIG. 7.

At 1420, the method may include monitoring for one or more reference signals from a network entity to determine one or more BFIs with respect to communications between the UE and the network entity. The operations of 1420 may be performed in accordance with examples disclosed herein. In some examples, aspects of the operations of 1420 may be performed by a reference signal monitoring component 735, as described with reference to FIG. 7.

At 1425, the method may include transmitting, via the relay device and based on the periodicity, a BFD report prior to a beam failure declaration by the UE, where the beam failure declaration is based on a quantity of the one or more BFIs exceeding a threshold. The operations of 1425 may be performed in accordance with examples disclosed herein. In some examples, aspects of the operations of 1425 may be performed by an BFD report transmitter 740, as described with reference to FIG. 7.

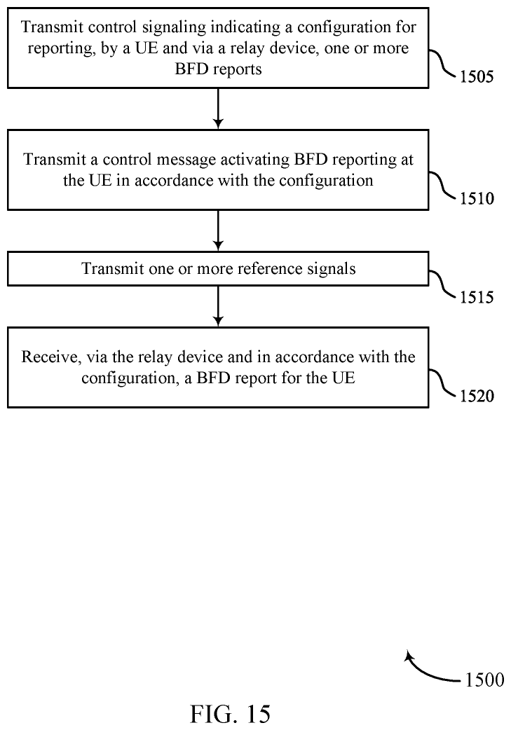

FIG. 15 shows a flowchart illustrating a method 1500 that supports relaying BFD reports in accordance with one or more aspects of the present disclosure. The operations of the method 1500 may be implemented by a network entity or various components of a UE, as described herein. For example, the operations of the method 1500 may be performed by a network entity 105, as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include transmitting control signaling indicating a configuration for reporting, by a UE and via a relay device, one or more BFD reports. The operations of 1505 may be performed in accordance with examples disclosed herein. In some examples, aspects of the operations of 1505 may be performed by a control signaling transmitter 1125, as described with reference to FIG. 11.

At 1510, the method may include transmitting a control message activating BFD reporting at the UE in accordance with the configuration. The operations of 1510 may be performed in accordance with examples disclosed herein. In some examples, aspects of the operations of 1510 may be performed by a control message transmitter 1130, as described with reference to FIG. 11.

At 1515, the method may include transmitting one or more reference signals. The operations of 1515 may be performed in accordance with examples disclosed herein. In some examples, aspects of the operations of 1515 may be performed by a reference signal transmitter 1135, as described with reference to FIG. 11.

At 1520, the method may include receiving, via the relay device and in accordance with the configuration, a BFD report for the UE. The operations of 1520 may be performed in accordance with examples disclosed herein. In some examples, aspects of the operations of 1520 may be performed by an BFD report receiver 1140, as described with reference to FIG. 11.

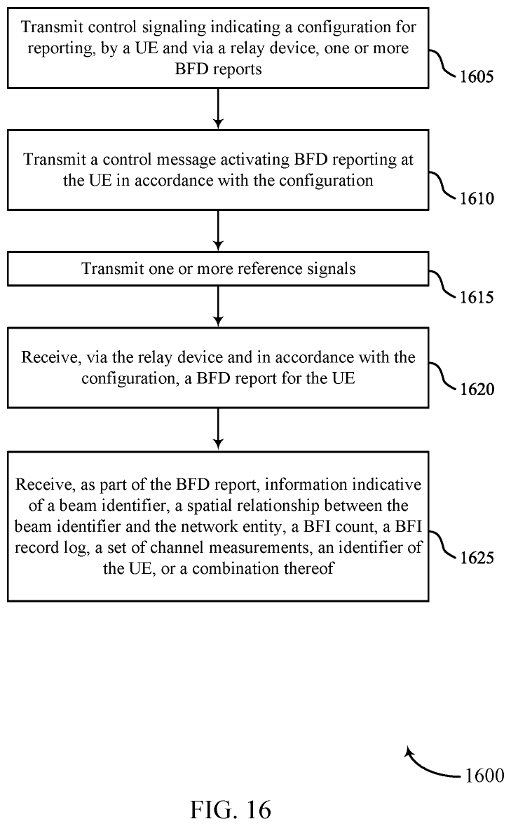

FIG. 16 shows a flowchart illustrating a method 1600 that supports relaying BFD reports in accordance with one or more aspects of the present disclosure. The operations of the method 1600 may be implemented by a network entity or various components of a UE, as described herein. For example, the operations of the method 1600 may be performed by a network entity 105, as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting control signaling indicating a configuration for reporting, by a UE and via a relay device, one or more BFD reports. The operations of 1605 may be performed in accordance with examples disclosed herein. In some examples, aspects of the operations of 1605 may be performed by a control signaling transmitter 1125, as described with reference to FIG. 11.

At 1610, the method may include transmitting a control message activating BFD reporting at the UE in accordance with the configuration. The operations of 1610 may be performed in accordance with examples disclosed herein. In some examples, aspects of the operations of 1610 may be performed by a control message transmitter 1130, as described with reference to FIG. 11.

At 1615, the method may include transmitting one or more reference signals. The operations of 1615 may be performed in accordance with examples disclosed herein. In some examples, aspects of the operations of 1615 may be performed by a reference signal transmitter 1135, as described with reference to FIG. 11.

At 1620, the method may include receiving, via the relay device and in accordance with the configuration, a BFD report for the UE. The operations of 1620 may be performed in accordance with examples disclosed herein. In some examples, aspects of the operations of 1620 may be performed by an BFD report receiver 1140, as described with reference to FIG. 11.

At 1625, the method may include receiving, as part of the BFD report, information indicative of a beam identifier, a spatial relationship between the beam identifier and the network entity, a BFI count, a BFI record log, a set of channel measurements, an identifier of the UE, or a combination thereof. The operations of 1625 may be performed in accordance with examples disclosed herein. In some examples, aspects of the operations of 1625 may be performed by an BFD report receiver 1140, as described with reference to FIG. 11.

The following provides an overview of aspects of the present disclosure:

Aspect 1: A method for wireless communications at a UE, comprising: receiving control signaling indicating a configuration for reporting, via a relay device, one or more beam failure detection reports; receiving a control message activating beam failure detection reporting at the UE in accordance with the configuration; monitoring for one or more reference signals from a network entity to determine one or more beam failure instances with respect to communications between the UE and the network entity; and transmitting, via the relay device and in accordance with the configuration, a beam failure detection report prior to a beam failure declaration by the UE, wherein the beam failure declaration is based at least in part on a quantity of the one or more beam failure instances exceeding a threshold.

Aspect 2: The method of aspect 1, wherein receiving the control signaling comprises: receiving, as part of the control signaling, information indicative of a periodicity for reporting, via the relay device, one or more beam failure detection reports, wherein transmitting the beam failure detection report is based at least in part on the periodicity.

Aspect 3: The method of aspect 1, wherein transmitting the beam failure detection report comprises: transmitting an aperiodic beam failure detection report based at least in part on determining that one or more trigger conditions have been satisfied.

Aspect 4: The method of aspect 3, wherein receiving the control signaling comprises: receiving, as part of the control signaling, information indicative of the one or more trigger conditions for reporting, via the relay device, one or more aperiodic beam failure detection reports.

Aspect 5: The method of any of aspects 3 through 4, wherein the one or more trigger conditions are based at least in part on a quantity of consecutive beam failure instances exceeding a threshold, a total quantity of beam failure instances exceeding a threshold percentage of a parameter, a change in channel strength exceeding a threshold, or a combination thereof.

Aspect 6: The method of any of aspects 1 through 5, wherein transmitting the beam failure detection report comprises: transmitting, as part of the beam failure detection report, information indicative of a beam identifier, a spatial relationship between the beam identifier and the network entity, a beam failure instance count associated with the one or more beam failure instances, a beam failure instance record log, a set of channel measurements, an identifier of the UE, or a combination thereof.

Aspect 7: The method of aspect 6, wherein the set of channel measurements comprises a signal to interference and noise ratio, a reference signal received power measurement, a pathloss measurement, an interference value, or a combination thereof.

Aspect 8: The method of any of aspects 1 through 7, wherein receiving the control signaling comprises: receiving information indicative of a plurality of configurations for reporting, via the relay device, one or more beam failure detection reports.

Aspect 9: The method of aspect 8, wherein receiving the control message comprises: receiving an indication that beam failure detection reporting is activated at the UE in accordance with a first configuration of the plurality of configurations.

Aspect 10: The method of any of aspects 8 through 9, further comprising: receiving one or both of a medium access control-control element or downlink control information indicating that the UE is to switch from a first configuration of the plurality of configurations to a second configuration of the plurality of configurations.

Aspect 11: The method of any of aspects 1 through 10, further comprising: transmitting a request to activate beam failure detection reporting at the UE, wherein receiving the control message is based at least in part on transmitting the request.

Aspect 12: The method of aspect 11, wherein transmitting the request comprises: transmitting one or both of a medium access control-control element or uplink control information indicating the request to activate beam failure detection reporting at the UE.

Aspect 13: The method of any of aspects 1 through 12, further comprising: receiving a beam switch command based at least in part on transmitting the beam failure detection report.

Aspect 14: The method of aspect 13, wherein receiving the beam switch command comprises: receiving one or both of a medium access control-control element or downlink control information indicating the beam switch command.

Aspect 15: The method of any of aspects 1 through 14, further comprising: monitoring for a set of reference signals from the network entity based at least in part on transmitting the beam failure detection report.

Aspect 16: The method of any of aspects 1 through 15, wherein transmitting the beam failure detection report comprises: transmitting, via the relay device and in accordance with the configuration, a sidelink medium access control-control element comprising the beam failure detection report.

Aspect 17: The method of any of aspects 1 through 16, wherein receiving the control signaling comprises: receiving radio resource control signaling indicating the configuration for reporting, via the relay device, one or more beam failure detection reports.

Aspect 18: The method of any of aspects 1 through 17, wherein receiving the control message comprises: receiving one or both of a medium access control-control element or downlink control information activating beam failure detection reporting at the UE in accordance with the configuration.

Aspect 19: A method for wireless communications at a network entity, comprising: transmitting control signaling indicating a configuration for reporting, by a UE and via a relay device, one or more beam failure detection reports; transmitting a control message activating beam failure detection reporting at the UE in accordance with the configuration; transmitting one or more reference signals; and receiving, via the relay device and in accordance with the configuration, a beam failure detection report for the UE.

Aspect 20: The method of aspect 19, wherein transmitting the control signaling comprises: transmitting, as part of the control signaling, information indicative of a periodicity for the UE to report, via the relay device, one or more beam failure detection reports, wherein receiving the beam failure detection report is based at least in part on the periodicity.

Aspect 21: The method of aspect 19, wherein transmitting the control signaling comprises: transmitting, as part of the control signaling, information indicative of one or more trigger conditions for the UE to report, via the relay device, one or more aperiodic beam failure detection reports.

Aspect 22: The method of aspect 21, wherein the one or more trigger conditions are based at least in part on a quantity of consecutive beam failure instances exceeding a threshold, a total quantity of beam failure instances exceeding a threshold percentage of a parameter, a change in channel strength exceeding a threshold, or a combination thereof.

Aspect 23: The method of any of aspects 19 through 22, wherein receiving the beam failure detection report comprises: receiving, as part of the beam failure detection report, information indicative of a beam identifier, a spatial relationship between the beam identifier and the network entity, a beam failure instance count, a beam failure instance record log, a set of channel measurements, an identifier of the UE, or a combination thereof.

Aspect 24: The method of any of aspects 19 through 23, further comprising: transmitting a beam switch command for the UE based at least in part on receiving the beam failure detection report.

Aspect 25: The method of aspect 24, wherein transmitting the beam switch command comprises: transmitting the beam switch command for the UE based at least in part on a beam failure instance count indicated by the beam failure detection report, a set of channel measurements indicated by the beam failure detection report, a beam failure instance reporting log indicated by the beam failure detection report, a beam failure instance count threshold, or a combination thereof.

Aspect 26: The method of any of aspects 19 through 25, wherein transmitting the control message comprises: transmitting the control message activating beam failure reporting at the UE based at least in part on a quality of service threshold, a discontinuous reception configuration of the UE, a discontinuous reception cycle length of the UE, an active discontinuous reception duration of the UE, an inactive discontinuous reception duration of the UE, a capability of the UE, or a combination thereof.

Aspect 27: An apparatus for wireless communications, comprising a processor; memory coupled with the processor; and instructions stored in the memory and executable by the processor to cause the apparatus to perform a method of any of aspects 1 through 18.

Aspect 28: An apparatus for wireless communications, comprising at least one means for performing a method of any of aspects 1 through 18.

Aspect 29: A non-transitory computer-readable medium storing code for wireless communications, the code comprising instructions executable by a processor to perform a method of any of aspects 1 through 18.

Aspect 30: An apparatus for wireless communications, comprising a processor; memory coupled with the processor; and instructions stored in the memory and executable by the processor to cause the apparatus to perform a method of any of aspects 19 through 26.

Aspect 31: An apparatus for wireless communications, comprising at least one means for performing a method of any of aspects 19 through 26.

Aspect 32: A non-transitory computer-readable medium storing code for wireless communications, the code comprising instructions executable by a processor to perform a method of any of aspects 19 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving control signaling indicating a configuration for reporting, via a relay device, one or more beam failure detection reports;
receiving a control message activating beam failure detection reporting at the UE in accordance with the configuration;
monitoring for one or more reference signals from a network entity to determine one or more beam failure instances with respect to communications between the UE and the network entity; and
transmitting, via the relay device and in accordance with the configuration, a beam failure detection report prior to a beam failure declaration by the UE, wherein the beam failure declaration is based at least in part on a quantity of the one or more beam failure instances exceeding a threshold.

2. The method of claim 1, wherein receiving the control signaling comprises:
receiving, as part of the control signaling, information indicative of a periodicity for reporting, via the relay device, one or more beam failure detection reports, wherein transmitting the beam failure detection report is based at least in part on the periodicity.

3. The method of claim 1, wherein transmitting the beam failure detection report comprises:
transmitting an aperiodic beam failure detection report based at least in part on determining that one or more trigger conditions have been satisfied.

4. The method of claim 3, wherein receiving the control signaling comprises:
receiving, as part of the control signaling, information indicative of the one or more trigger conditions for reporting, via the relay device, one or more aperiodic beam failure detection reports.

5. The method of claim 3, wherein the one or more trigger conditions are based at least in part on a quantity of consecutive beam failure instances exceeding a threshold, a total quantity of beam failure instances exceeding a threshold percentage of a parameter, a change in channel strength exceeding a threshold, or a combination thereof.

6. The method of claim 1, wherein transmitting the beam failure detection report comprises:
transmitting, as part of the beam failure detection report, information indicative of a beam identifier, a spatial relationship between the beam identifier and the network entity, a beam failure instance count associated with the one or more beam failure instances, a beam failure instance record log, a set of channel measurements, an identifier of the UE, or a combination thereof.

7. The method of claim 6, wherein the set of channel measurements comprises a signal to interference and noise ratio, a reference signal received power measurement, a pathloss measurement, an interference value, or a combination thereof.

8. The method of claim 1, wherein receiving the control signaling comprises:
receiving information indicative of a plurality of configurations for reporting, via the relay device, one or more beam failure detection reports.

9. The method of claim 8, wherein receiving the control message comprises:
receiving an indication that beam failure detection reporting is activated at the UE in accordance with a first configuration of the plurality of configurations.

10. The method of claim 8, further comprising:
receiving one or both of a medium access control-control element or downlink control information indicating that the UE is to switch from a first configuration of the plurality of configurations to a second configuration of the plurality of configurations.

11. The method of claim 1, further comprising:
transmitting a request to activate beam failure detection reporting at the UE, wherein receiving the control message is based at least in part on transmitting the request.

12. The method of claim 11, wherein transmitting the request comprises:
transmitting one or both of a medium access control-control element or uplink control information indicating the request to activate beam failure detection reporting at the UE.

13. The method of claim 1, further comprising:
receiving a beam switch command based at least in part on transmitting the beam failure detection report.

14. The method of claim 13, wherein receiving the beam switch command comprises:
receiving one or both of a medium access control-control element or downlink control information indicating the beam switch command.

15. The method of claim 1, further comprising:
monitoring for a set of reference signals from the network entity based at least in part on transmitting the beam failure detection report.

16. The method of claim 1, wherein transmitting the beam failure detection report comprises:
transmitting, via the relay device and in accordance with the configuration, a sidelink medium access control-control element comprising the beam failure detection report.

17. The method of claim 1, wherein receiving the control signaling comprises:
receiving radio resource control signaling indicating the configuration for reporting, via the relay device, one or more beam failure detection reports.

18. The method of claim 1, wherein receiving the control message comprises:
receiving one or both of a medium access control-control element or downlink control information activating beam failure detection reporting at the UE in accordance with the configuration.

19. A method for wireless communications at a network entity, comprising:
transmitting control signaling indicating a configuration for reporting, by a user equipment (UE) and via a relay device, one or more beam failure detection reports;
transmitting a control message activating beam failure detection reporting at the UE in accordance with the configuration;
transmitting one or more reference signals; and
receiving, via the relay device and in accordance with the configuration, a beam failure detection report for the UE.

20. The method of claim 19, wherein transmitting the control signaling comprises:
transmitting, as part of the control signaling, information indicative of a periodicity for the UE to report, via the relay device, one or more beam failure detection reports, wherein receiving the beam failure detection report is based at least in part on the periodicity.

21. The method of claim 19, wherein transmitting the control signaling comprises:
transmitting, as part of the control signaling, information indicative of one or more trigger conditions for the UE to report, via the relay device, one or more aperiodic beam failure detection reports.

22. The method of claim 21, wherein the one or more trigger conditions are based at least in part on a quantity of consecutive beam failure instances exceeding a threshold, a total quantity of beam failure instances exceeding a threshold percentage of a parameter, a change in channel strength exceeding a threshold, or a combination thereof.

23. The method of claim 19, wherein receiving the beam failure detection report comprises:
receiving, as part of the beam failure detection report, information indicative of a beam identifier, a spatial relationship between the beam identifier and the network entity, a beam failure instance count, a beam failure instance record log, a set of channel measurements, an identifier of the UE, or a combination thereof.

24. The method of claim 19, further comprising:
transmitting a beam switch command for the UE based at least in part on receiving the beam failure detection report.

25. The method of claim 24, wherein transmitting the beam switch command comprises:
transmitting the beam switch command for the UE based at least in part on a beam failure instance count indicated by the beam failure detection report, a set of channel measurements indicated by the beam failure detection report, a beam failure instance reporting log indicated by the beam failure detection report, a beam failure instance count threshold, or a combination thereof.

26. The method of claim 19, wherein transmitting the control message comprises:
transmitting the control message activating beam failure reporting at the UE based at least in part on a quality of service threshold, a discontinuous reception configuration of the UE, a discontinuous reception cycle length of the UE, an active discontinuous reception duration of the UE, an inactive discontinuous reception duration of the UE, a capability of the UE, or a combination thereof.

27. An apparatus for wireless communications, comprising:
a processor;
memory coupled with the processor; and
instructions stored in the memory and executable by the processor to cause the apparatus to:
receive control signaling indicating a configuration for reporting, via a relay device, one or more beam failure detection reports;
receive a control message activating beam failure detection reporting at the apparatus in accordance with the configuration;
monitor for one or more reference signals from a network entity to determine one or more beam failure instances with respect to communications between the apparatus and the network entity; and
transmit, via the relay device and in accordance with the configuration, a beam failure detection report prior to a beam failure declaration by the apparatus, wherein the beam failure declaration is based at least in part on a quantity of the one or more beam failure instances exceeding a threshold.

28. The apparatus of claim 27, wherein the instructions to receive the control signaling are executable by the processor to cause the apparatus to:
receive, as part of the control signaling, information indicative of a periodicity for reporting, via the relay device, one or more beam failure detection reports, wherein transmitting the beam failure detection report is based at least in part on the periodicity.

29. An apparatus for wireless communications, comprising:
a processor;
memory coupled with the processor; and
instructions stored in the memory and executable by the processor to cause the apparatus to:
transmit control signaling indicating a configuration for reporting, by a user equipment (UE) and via a relay device, one or more beam failure detection reports;
transmit a control message activating beam failure detection reporting at the UE in accordance with the configuration;
transmit one or more reference signals; and
receive, via the relay device and in accordance with the configuration, a beam failure detection report for the UE.

30. The apparatus of claim 29, wherein the instructions to receive the beam failure detection report are executable by the processor to cause the apparatus to:
receive, as part of the beam failure detection report, information indicative of a beam identifier, a spatial relationship between the beam identifier and the apparatus, a beam failure instance count, a beam failure instance record log, a set of channel measurements, an identifier of the UE, or a combination thereof.
